(19) United States
(12) Patent Application Publication
(10) Pub. No.: US 2008/0205791 A1
(43) Pub. Date: Aug. 28, 2008

(54) METHODS AND SYSTEMS FOR USE IN 3D VIDEO GENERATION, STORAGE AND COMPRESSION

(75) Inventors: Ianir IDESES, Tel-Mond (IL); Barak Fishbain, Shoham (IL); Leonid Yaroslavsky, Kfar Saba (IL); Roni Vituch, Petach Tikva (IL)

Correspondence Address: BROWDY AND NEIMARK, P.L.L.C.;624 NINTH STREET, NW, SUITE 300, WASHINGTON, DC, 20001-5303, US

(73) Assignee: Ramot at Tel-Aviv University Ltd., Tel-Aviv (IL)

(21) Appl. No.: 11/939,162

(22) Filed: Nov. 13, 2007

Related U.S. Application Data
(60) Provisional application No. 60/858,334, filed on Nov. 13, 2006.

(51) Int. Cl. G06K 9/54; G06K 9/32

(52) U.S. Cl. 382/285; 382/305

(57) ABSTRACT

A memory storage device readable by machine is presented, the device tangibly embodying a sequence of depth maps associated with a continuous scene sequence of digital 2D images of a predetermined resolution, the sequence of depth maps including at least one restricted redundancy depth map of a resolution lower than the predetermined resolution of the 2D images. The depth maps may be used for 3D (i.e. stereo) visualization.

### FIELD OF THE INVENTION

This invention is generally in the field of image processing techniques and relates to methods and systems for generating and displaying stereoscopic (3D) video from 2D video, storing 2D video, 3D video and 3D video related data, and compressing 2D video and 3D video.

### REFERENCES

[1] I. Ideses, L. Yaroslavsky, “Efficient Compression and Synthesis of Stereoscopic Video”, 2nd IASTED International Conference, Visualization, Imaging and Image Processing (VIIP 2002), 2002, pp. 191-194;

[2] I. Ideses, L. Yaroslavsky, “New Methods to Produce High Quality Color Anaglyphs for 3-D Visualization”, in Aurelio C. Campilho, Mohamed S. Kamel (Eds.): Image Analysis and Recognition: International Conference, ICIAR 2004, Porto, Portugal, Sep. 29-Oct. 1, 2004, Proceedings, Part II. Lecture Notes in Computer Science 3212 Springer, 2004, pp. 273-280;

[3] I. Ideses, L. Yaroslavsky, “3 Methods to Improve Quality of Colour Anaglyphs”, Journal of Optics A: Pure and Applied Optics, Vol. 7, Number 12, pp. 755-762(8), 2005;

[4] Yaroslavsky L. P. “On redundancy of stereoscopic pictures”, Image Science'85 Proc. (Helsinki, Finland, June 1985), vol. 1, pp 82-85, Acta Polytech. Scand. (149);

[5] L. P. Yaroslavsky, “A Method for Vizualization of Stereoscopic Images”, Hivatal az Okirathoz fuzott Leiras Alapjan 196007 Lajstromszamon szabadalmat adott. A Szabadalmi Bejelentes Napja es az Oltami ido Kezdete, 1986, 07.18. (Hungary);

[6] L. Yaroslavsky, “Digital Signal Processing in Optics and Holography”, Radio I Svyaz', Moscow, 1987, p. 29, (In. Russian);

[7] I. Ideses, L. Yaroslavsky “A Method for Generating 3D Video from a Single Video Stream”, Proceedings of the Vision, Modeling, and Visualization Conference (VMV 2002), Erlangen, Germany, 2002, 435-438;

[8] B. K. P. Horn and M. J. Brooks, “The variational approach to shape from shading,” Comp. vision, Graphics, and Image Processing, vol. 33, no. 2, pp. 174-208, Feb. 1986;

[9] A. Tankus, N. Sochen, and Y. Yeshurun. A New Perspective [on] Shape-from-Shading. In ICCV 2003, pages 862-869;

[10] Y. Y. Schechner and N. Kiryati, Depth from Defocus vs. Stereo: How Different Really are They?, International Journal of Computer Vision (IJCV), Vol. 39, pp. 141-162, 2000;

[11] Lucas, B., and Kanade, T.: An Iterative Image Registration Technique with an Application to Stereo Vision”. Proceedings of 7th International Joint Conference on Artificial Intelligence (IJCAI), pp. 674-679 (1981);

[12] B. Horn and B. Schunck.: Determining Optical Flow. Artificial Intelligence, 17:185-203 (1981);

[13] Senthil Periaswamy, Hany Farid: Elastic Registration in the Presence of Intensity Variations. IEEE Transactions on Medical Imaging, Volume 22, Number 7 (2003);

[14] Yu-Te Wu, Takeo Kanade, Ching-Chung Li and Jeffrey Cohn: Image Registration Using Wavelet-Based Motion Model. International Journal of Computer Vision (2000);

[15] L. Alvarez, R. Deriche, J. Sanchez, and J. Weickert: Dense Disparity Map Estimation Respecting Image Discontinuities: A PDE and Scalespace Based Approach. Technical Report” RR-3874, INRIA (2000);

[16] Jochen Schmidt, Heinrich Niemann, and Sebastian Vogt.: Dense disparity maps in real-time with an application to augmented reality. Orlando, Fla. USA,. IEEE Computer Society, December 3-4 (2002), IEEE Workshop on Applications of Computer Vision (WACV 2002);

[17] Adee Ran, Nir A. Sochen.: Differential Geometry Techniques in Stereo Vision Proceedings of EWCG, pp 98-103 (2000).

### BACKGROUND

3D video synthesis and visualization is a growing field in the entertainment and gaming markets. Interest in 3D visualization and 3D content has been constantly growing as imaging devices were developed. Typically, two issues have to be addressed for 3D visualization: (i) how to display 3D content when it is available and (ii) how to acquire 3D data.

There are several ways for displaying 3D images. Most methods for 3D display are based on stereopsis, which is one of the most important visual mechanisms of 3D vision. For example, stereoscopes are useful as they utilize the stereopsis. Stereoscopic and, in particular, autostereoscopic displays as well utilize the stereopsis. These devices exhibit excellent stereo perception in color and are considered the high-end solution for 3D visualization. However, overall cost, viewing area limitations and vision fatigue they cause still inhibit the market share of such devices.

Some simple and inexpensive methods of visualization involve use of so-called anaglyphs, these methods also use stereopsis for 3D perception. Anaglyph images provide a stereoscopic 3D effect when viewed with two-color glasses (each lens a different color). Images are made up of two color layers, superimposed, but each containing a different view to produce a depth effect. Often, the main subject is in the center, while the foreground and background are shifted laterally in opposite directions. The picture contains two differently filtered colored images, one for each eye. When viewed through the “color coded” “anaglyph glasses”, they reveal an integrated stereoscopic image. The visual cortex of the brain fuses this into perception of a three dimensional scene or composition.

Anaglyph images have seen a recent resurgence due to the presentation of images and video on the internet, CDs, and even in print. Low cost paper frames or plastic-framed glasses hold accurate color filters, that typically tend to make use of all three primary colors (especially after 2002). The current most frequent option is red for one channel (usually the left) and a combination of both blue and green in the other filter.

In some cases, anaglyphs are intended not only for 3D viewing with color glasses, but also for 2D viewing with unaided eyes. Such dual purpose, 2D/3D compatible anaglyphs are prepared by special processing of stereo pair images, for minimizing visible mis-registration of the two anaglyph layers or, in other words, for removing ghosting artifacts. The 3D information is encoded into the 2D/3D compatible image with less parallax than in conventional anaglyphs.

Despite that there are relatively many ways to display 3D images and video, existing 3D content is still limited. This is mainly due to the fact that though 3D video content can be synthesized from two synchronized 2D video streams, for example obtained by two synchronized video cameras separated by some predefined parallax, the process of 3D video and still 3D image acquisition is complicated and requires detailed attention to the acquiring device setup. In particular, attention must be paid to the distance between the two cameras, inter-camera synchronization, as well as zoom and focal properties of the stereo setup. In addition, stereo setups do not enable use of multi-view displays.

In [1] (a work of inventors of the present patent application) the focus was on the issue of stereoscopic data transmission. In this connection, first, methods for compression of stereoscopic images and video and, second, methods for synthesis of 2D/3D viewable video from the compressed data were suggested. The preferred compression method was to involve creation of either 3- or 4-color component anaglyphs from stereo pairs and image decimation and JPEG compression of respectively one or two color components of the prepared standard or enhanced anaglyphs. The preferred synthesis method was to include mutual alignment of color components for every frame of the video. It was also suggested that the object alignment would use CODECs with motion compensation support as this would allow localizing objects in key frames of the video and utilizing motion vector information about the movement of the objects in the stereoscopic video pair for determining the offset needed for the alignment. The issue of stereoscopic data acquisition was not addressed in [1].

Work [2] (also of inventors of the present patent application) was devoted to production of anaglyphs themselves. In particular, the authors addressed an issue that standard anaglyph-based projection of stereoscopic images usually yielded low quality images characterized by ghosting effects and loss of color perception for 2D and 3D viewing. In this connection they proposed methods for improving quality of anaglyph images, as well as conserving image color perception, and reducing discomfort in prolonged viewing. The methods of production of high quality anaglyphs were to include image alignment within the stereo pair and use of an operation (non-linear scaling) on synthesized depth maps. In particular, there were provided methods for reducing non-overlapping areas in synthesized anaglyphs while retaining information within the depth map.

The proposed modifications of the depth map were to utilize an idea that stereoscopic projection for visual observation would not require high accuracy in depth perception ([4], revisited / reiterated in [5] and [6]). For calculating the depth map of a stereo pair, position of every object pixel of the right image in the left image and the horizontal parallax between the images were to be calculated. In this connection the authors suggested a method that would generate the depth map for every pixel of the right image.

The same authors addressed the issue of quality of colour anaglyphs and methods for reducing the ghosting artifacts also in journal publication [3]. It was recognized that artifacts were a direct result of the process of the stereo pair acquisition. The camera setup had a great impact on the ghosting effects. In theory, these artifacts could be greatly reduced by acquiring images with low parallax. Capturing images with low parallax, however, resulted in images of low 3D perception. This tradeoff, therefore, prevented acquisition of 3D images with low artifacts, high visual quality, and high 3D perception.

More typical way of video acquisition results in 2D video. It would be beneficial to convert 2D video to 3D video. One proposed method of conversion would rely on simple time delay between frames and adjustment of left-right images [7] (this work is also of inventors of the present patent application). In the proposed method computations would only be necessary in order to align the images in the case of anaglyph projection and in order to assess which image corresponds to the left eye and which to the right eye. This method would be mostly suited for videos that contain lateral or rotational motion and it would not allow adjusting image parallax with the speed of the movement. The 3D perception was to be achieved by creating anaglyph images. The video synthesis was to be accomplished with help of hardware found in digital CATV (cable TV) and SATTV (satellite TV) equipment. The method of [7] would rely on object-wise localization and alignment performed on the stereo pair, but it might exploit properties of CODECs for reducing amount of computations.

### DESCRIPTION OF THE INVENTION

There is a need in the art to facilitate the conversion of 2D image data into a 3D representation. The inventors enable this conversion by providing a novel image processing technique utilizing video compression motion estimation for restricted redundancy depth map computation (or, in other terms, restricted redundancy horizontal parallax map computation; it should be understood that horizontal parallax, disparity, displacement and depth are synonymic to each other in this application).

The inventors have considered the following idea. 3D video content can be synthesized from a single 2D video stream and a series of depth maps corresponding to each video frame, by generating from these stream and series the second 2D video stream or generating an anaglyph stream. Depth maps thus can be used to generate synthetic artificial views: stereo pair for stereoscopic vision or multi-view for multi-view autostereoscopic display or anaglyph view. Using depth maps should be convenient as they contain information on the 3D shape of the scene, and therefore they would provide information for various applications. However, there is a problem in 3D synthesis associated with acquiring scene depth maps. In order to synthesize depth maps, one has to find, typically, for pixels in one image of the stereo pair their corresponding pixels in the other image. Accordingly, calculating the parallax typically means essentially performing pixel by pixel target location operations. In the case of 2D video streams, if temporally adjacent frames are to be treated as stereo pairs, the localization procedure, performed for each pixel would be time consuming and expensive in computational terms. Therefore it would be beneficial to utilize the redundancy of stereoscopic images and generate suitable depth maps having substantially lower spatial resolution than of a single 2D image/frame. The above mentioned restricted redundancy depth maps (RRDMs) to be used can thus be low resolution depth maps (LRDMs), and generation of depth maps for 2D video stream would treat temporally adjacent or close frames as stereo pairs. Since much of 2D video content is compressed or will be compressed, it would be convenient to generate the restricted redundancy depth maps by utilizing properties or data present in the compressed 2D video. Therefore the inventors have decided to utilize motion vectors encoded in the compressed video for production of the depth maps and synthesis of artificial 3D views, for example in the form of anaglyphs. In other words, the inventors' technique allows utilizing motion vectors used for efficient compression of 2D video for generating low resolution depth maps for sequential frames of the 2D video treated as stereo pairs and synthesizing from these frames and depth maps artificial 3D video. Such a technique allows avoiding double work that would be done had compression of 2D video for presentation of 2D video and compression of 2D video for presentation of 3D video been different.

With regards to depth maps, the following should be noted. A depth map is an array of data that represents the depth of the objects in the spatial coordinates of the stereo pair. According to the triangulation principle, the value of the depth map, h(x, y), in each pixel (x, y) in the stereo pair is proportional to the mutual displacement (horizontal parallax), d(x, y), of the corresponding pixels in two images of the stereo pair h(x, y)=Cd(x, y), the proportionality coefficient C being determined by the optical properties of the imaging devices and the spatial coordinates of the pixels in the stereo pair. Thus, in order to calculate h(x, y) it is sufficient to find, for every pixel of one image, the coordinates of its corresponding pixel in the second image. In stereo pair images, the depth map can be estimated from various stereo cues, among them are: depth from occlusion [8], depth from shading [9] and depth from focus [10]. These depth maps can also be explicitly computed using localization and triangulation in stereo pair images. As well, some methods to compute depth maps are presented in [11-17]. All these methods imply computationally intensive operations. The inventors' technique may utilize a depth from motion or block motion estimate for calculating depth maps.

In some preferred embodiments of the inventors' technique the depth map resolution is selected so as not to cause a loss of 3D perception. In this connection, the inventors have considered that depth maps can be primarily based on pixel blocks of a size 4×4, which is often used in the latest MPEG CODECs (eg H.264). As well, depth maps can be primarily based on or may have pixel blocks of sizes 8×8, 10×10, 12×12, 16×16. The resulting depth map structure would match capabilities of typical modern codecs (e.g. based on MPEG or MPEG4). Other block dimensions, including unequal in x- and y-axes, are acceptable as well if they preserve the 3D perception. Using blocks smaller in one dimension than 4 pixels might correspond to redundant depth maps and less efficient compression. Though the depth maps can be interpolated and have different values for different pixels within blocks, those depth maps which are created based on an intermediate depth map with a number of depth values being equal to a number of blocks are considered as having the same resolution as this intermediate depth map in this application. With regards to the ghosting artifacts, the alignment for removing the ghosting effects in anaglyphs may be performed, but is not required. In some embodiments, the alignment includes non-linear scaling of the depth map. In some preferred embodiments, also object-wise localization operations are not used, as instead of them block localization operations are used. Such a method is especially applicable in those cases when the 2D video contains moving objects. In other words, in such cases a pair of sequential frames would significantly differ from a stereoscopic pair. It should be noted, however, that the use of block motion vectors allows removing some constraints on the camera motion, for example the camera may even remain still and objects may move. And in the case when anaglyph enhancement is needed, it can be performed by color component defocusing, as well as by the depth map compression, as mentioned above.

Thus, the inventors' technique provides a novel method for synthesis of 3D video from 2D video which utilizes restricted redundancy or low resolution or block-based depth maps, i.e. maps resolving depth up to pixel clusters rather than to individual pixels. The present technique also provides a novel method for synthesis of block-based low resolution depth maps which utilizes extraction, from 2D video sequences, motion estimation data. In particular, the invented method can utilize the extraction of motion estimation data from block-compressed 2D video sequences. The present invention enables efficient synthesis of 3D video sequences from 2D video sequences and facilitates synthesis of 3D video in real time allowing 3D playback on low end hardware or thin clients.

It should be noted/reiterated, that the extraction of motion estimation data can be performed very efficiently for some types of compressed 2D video sequences, for example for sequences coded with modern standard codecs, such as MPEG 2 and MPEG 4. In fact, most of the modern codecs encode motion estimation data into 2D video while performing temporal compression. For example, the MPEG standard codec relies on two forms of compression: interframe and intraframe compression. From these two the former, i.e. the interframe compression, takes advantage of time domain redundancy of video sequences. In interframe compression, object blocks are labeled (in the initial frame or a key frame of continuous scene sequence), and acquired motion vectors point the future location of the blocks. This enables the CODEC to significantly compress the video stream. According to the inventors' technique, it is possible to use these encoded motion vectors not only for decompressing coded 2D video into a viewable 2D video, but also for creating depth maps for 3D video.

According to the inventors' technique, motion vectors, found in a motion compensation coded 2D video sequence, can be used to synthesize depth maps that describe 3D scenes, and to generate, using these maps, a new artificial 3D stereo video sequence. In some implementations, the motion vectors are used directly for computing the depth maps. In some other implementations, spatial and/or temporal interpolation is used to fill in missing motion vector blocks that are inherent in such compression standards, and the depth maps are post-processed to enable improvement of visual quality of synthesized 3D stereo video.

According to a broad aspect of the invention, there is provided a memory storage device readable by machine, the device tangibly embodying a sequence of depth maps associated with a continuous scene sequence of digital 2D images of a predetermined resolution, the sequence of depth maps including at least one restricted redundancy depth map of a resolution lower than the predetermined resolution of the 2D images.

The device may be for example a CD ROM or a hard drive of a computer or a disc-on-key memory. Certainly, other storage devices can also be used.

The memory storage device may tangibly embody the continuous scene sequence of 2D images.

The sequence of depth maps can be stored in a single data structure, in particular a single file (this can be useful for fast data access).

According to a broad aspect of the invention, there is provided a kit including the memory storage device as above, and a second memory storage device readable by machine, the second device tangibly embodying the continuous scene sequence of 2D images. The kit may for example include two CD-ROMs with respective data.

The continuous scene sequence of 2D images may be stored in a single data structure. The single data structure may be an MPEG-based file. The data structure including the sequence of digital 2D images may include the respective sequence of depth maps.

The sequence of digital 2D images may be coded by Block Matching Algorithm.

The restricted redundancy depth map may be of a resolution being in at least one direction at least 4 times lower than the predetermined resolution of digital 2D image associated with the depth map, the restricted redundancy depth map being thereby a low resolution depth map.

This low resolution may be at least 8 times, or 10 times, or 16 times lower than the predetermined resolution of digital 2D image associated with the depth map. In some embodiments, the low resolution may be kept at most 7 times lower than the predetermined resolution of digital 2D image associated with the depth map.

The restricted redundancy depth map may be of a resolution at least 3 times and at most 8 times lower than the predetermined resolution of digital 2D image associated with the depth map.

The specified resolution benchmarks may apply to both dimensions of the 2D image.

In particular, the restricted redundancy depth map may be in each of two crossed directions of resolution at least 4 times lower than the predetermined resolution of digital 2D image associated with the depth map.

Nowadays, movies/videos are often transmitted through Internet or other networks.

In this connection, in a broad aspect of the invention, there is provided a method of use of the memory storage device. The method includes initiating machine reading of the sequence of depth maps accommodated in the memory storage device and sending at least a portion of the read data to a network. The method thereby allows a user of the memory storage device to distribute stereoscopic video-related data through the network.

The method may include receiving the portion of the read data through the network, the receiving being performed at a terminal of a remotely located user. The method thereby may enable the remotely located user to access the stereoscopic video-related data through the network.

The initiating may include forming a network-passable initiating message and sending this message to the machine through the network, the forming and sending being performed at the terminal of the remotely located user.

In a broad aspect of the invention, there is provided a method of use of the memory storage device. The method includes administering a machine capable of reading the memory storage device to respond to a predetermined initiating signal to be received by the machine from a network, the response including reading the sequence of depth maps stored in the memory storage device and sending at least a portion of the read data to the network, the method thereby enabling a machine administrator to use the memory storage device as a stereoscopic video-related distributing terminal.

In a broad aspect of the invention, there is provided another method of use of the memory storage device. The method includes reading by a machine the sequence of depth maps stored in the memory storage device and generating by the machine a sequence of stereoscopic images using the read data and the associated sequence of 2D images, the generated sequence thereby including at least one restricted redundancy stereoscopically perceptible image.

The generating the sequence of stereoscopic images can include adapting this sequence for stereopsis. The generating the sequence of stereoscopic images may include forming a sequence of anaglyphs. The generating the sequence of stereoscopic images may include forming this sequence on a stereoscopic display.

The forming a sequence of anaglyphs may include the following:

producing a green-blue component of anaglyph from a green and a blue component of a digital 2D image of the sequence of digital 2D images,

producing a red component of anaglyph I_{anaglyph} (x,y) from a red component, I_{red} (x,y), of the digital 2D image and the depth map, D(x,y), associated with the 2D image, x and y being two axes of the 2D image, the producing including:
producing a stretched red component I_{stretched} (x,y) by stretching the red component I_{red}(x,y) of the digital 2D image, the stretched red component I_{stretched} (x,y) thereby having more pixels along the axis X than the red component I_{red}(x,y),
resampling the stretched red component I_{stretched} (x,y) by assigning to a pixel (x,y) of the anaglyph red component an intensity of red color I_{anaglyph} (x,y)=stretched (x+D,y)

The stretching the red component I_{red} (x,y) of the digital 2D image may include interpolating values of the stretched red component, I_{stretched} (x,y), that is being produced.

In a broad aspect of the invention, there is provided a method for use in machine conversion of 2D video to 3D video. The method includes generating a sequence of stereoscopic images by processing a continuous scene sequence of digital 2D images and a sequence of depth maps associated with the continuous scene sequence of digital 2D images, wherein the sequence of depth maps includes at least one restricted redundancy depth map being of a resolution lower than the 2D image, the generated sequence of the stereoscopic images thereby including at least one restricted redundancy stereoscopically perceptible image.

The continuous scene sequence of digital 2D images may be coded by a block matching algorithm.

The processing may form a sequence of anaglyphs from the continuous scene sequence of digital 2D images and the sequence of depth maps associated with the continuous scene sequence of digital 2D images.

At least one of the anaglyphs to be included into the sequence of anaglyphs may be formed by carrying out the following:

producing a green-blue component of the anaglyph from a green and a blue component of a digital 2D image of the sequence of digital 2D images,

producing a red component of the anaglyph I_{anaglyph} (x,y) from a red component, I_{red} (x,y), of the digital 2D image and the depth map, D(x,y), associated with the 2D image, x and y being two arbitrary axes of the 2D image, the producing including:
producing a stretched red component I_{stretched} (x,y) by stretching the red component I_{red} (x,y) of the digital 2D image, the stretched red component I_{stretched} (x,y) thereby having more pixels along the axis x than the red component I_{red} (x,y),
resampling the stretched red component I_{stretched} (x,y) by assigning to a pixel (x,y) an intensity of red color I_{anaglyph} (x,y)=I_{stretched} (x+D,y).

In a broad aspect of the invention, there is provided a program storage device readable by machine, tangibly embodying a program of instructions executable by the machine to perform the above method steps, where suitable.

In a broad aspect of the invention, there is provided a computer program product including a computer useable medium having computer readable program code embodied therein, the computer program product including computer readable program code for causing the computer to perform the above method, where suitable.

There is also provided a computer system including a computer and the computer program product. Computer system includes any calculating device in the art capable of producing the desired result.

In a broad aspect of the invention, there is provided a method of use of a 2D video coded by a Block Matching Algorithm, the method including accessing by a machine a continuous scene sequence of digital 2D images coded in the 2D video, accessing by the machine multipixel image portions motion data, associated with the continuous scene sequence of digital 2D images and coded in the 2D video, and generating by the machine a sequence of restricted redundancy stereoscopically perceptible images by processing the accessed sequence and motion data, the method thereby enabling t use of machine for conversion of 2D video to 3D video.

The generating may include calculating by the machine a sequence of restricted redundancy depth maps by using the accessed multipixel image portions motion data.

The calculating the sequence of restricted redundancy depth map may include assigning a depth D (x,y) to pixels of a multipixel image portion of a digital 2D image of the sequence of digital 2D images, the value being homomorphic to MVₓ and MV_{y} being two motion vectors, coded in the 2D video, of the multipixel image portion.

The calculating the sequence of restricted redundancy depth map may include assigning a depth D (x,y) a value of about \sqrt{MVₓ²+MV_{y}²} to pixels of a multipixel image portion of a digital 2D image of the sequence of digital 2D images, MVₓ and MV_{y} being two motion vectors, coded in the 2D video, of the multipixel image portion.

The value of depth may be truncated or rounded to a pixel.

In a broad aspect of the invention, there is provided a program storage device readable by machine, tangibly embodying a program of instructions executable by the machine to perform method steps, the method including the respective method.

In a broad aspect of the invention, there is provided a computer program product including a computer useable medium having computer readable program code embodied therein, the computer program product including computer readable program code for causing the computer to perform the the respective method.

There is also provided a computer system including a computer and the respective computer program product associated with the computer (e.g. run on it).

The multipixel image portions may be of a size being at least 4 pixels in an at least one direction.

In a broad aspect of the invention, there is provided a method, for use in 3D video compression, the method including accessing a continuous scene sequence of stereoscopic images, obtaining, using the accessed sequence, a sequence of digital 2D images, calculating a sequence of restricted redundancy depth maps being associated with the sequence of digital 2D images, the restricted redundancy depth maps being of resolution larger than the 3 pixels of the digital 2D images, including the calculated sequence of restricted redundancy depth maps in a data structure being tangibly embodied in a memory storage device readable by machine, the resulting data structure thereby accommodating stereoscopic video-related data.

The method may use including the obtained sequence of digital 2D images in a data structure being tangibly embodied in a memory storage device readable by machine.

The data structure including the obtained sequence of digital 2D images and the data structure including the calculated sequence of the restricted redundancy depth maps may be embodied by the same memory storage device readable by machine.

The obtained sequence of digital 2D images and the calculated sequence of the restricted redundancy depth maps may be included in the same data structure.

The obtained sequence of digital 2D images may be coded by a Block Matching Algorithm.

In a broad aspect of the invention, there is provided a program storage device readable by machine, tangibly embodying a program of instructions executable by the machine to perform the respective method.

In a broad aspect of the invention, there is provided a program computer program product including a computer useable medium having computer readable program code embodied therein, the computer program product including computer readable program code for causing the computer to perform the respective method.

There is also provided a computer system including a computer and the respective computer program product.

In a broad aspect of the invention, there is provided a memory storage device readable by machine, the device tangibly embodying a continuous scene sequence of 2D images of a predetermined resolution and a sequence of depth maps associated with the sequence of digital 2D images, the sequence of depth maps including at least one restricted redundancy depth map of a resolution lower than the predetermined resolution of the 2D images, the sequence of digital 2D images being coded by a Block Matching Algorithm, the restricted redundancy depth map being in at least one direction of a resolution at least 4 times lower than the predetermined resolution of digital 2D image associated with the depth map.

The restricted redundancy depth map may include interpolated values within its blocks.

Below is a continuation of the description of the invention having further details. References are made to the accompanying drawings, in which:

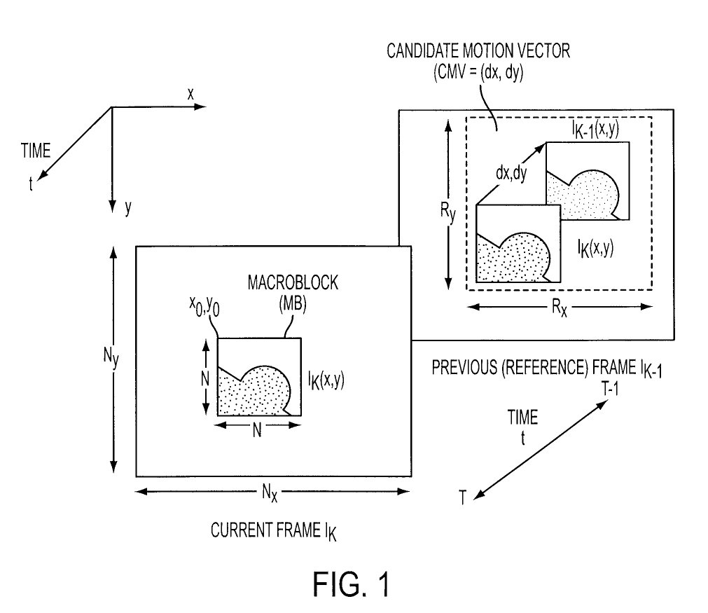

FIG. 1 is an illustration of the block matching algorithm working scheme suitable for generation of horizontal and vertical displacement maps;

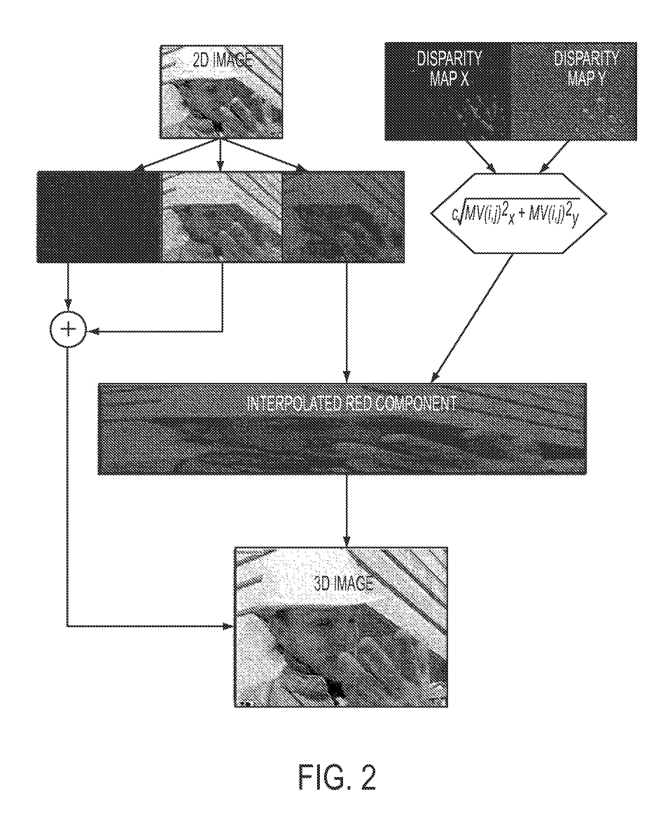

FIG. 2 is a flowchart for creating (synthesizing) a 3D image (an anaglyph) out of horizontal and vertical displacement-maps and single 2D image;

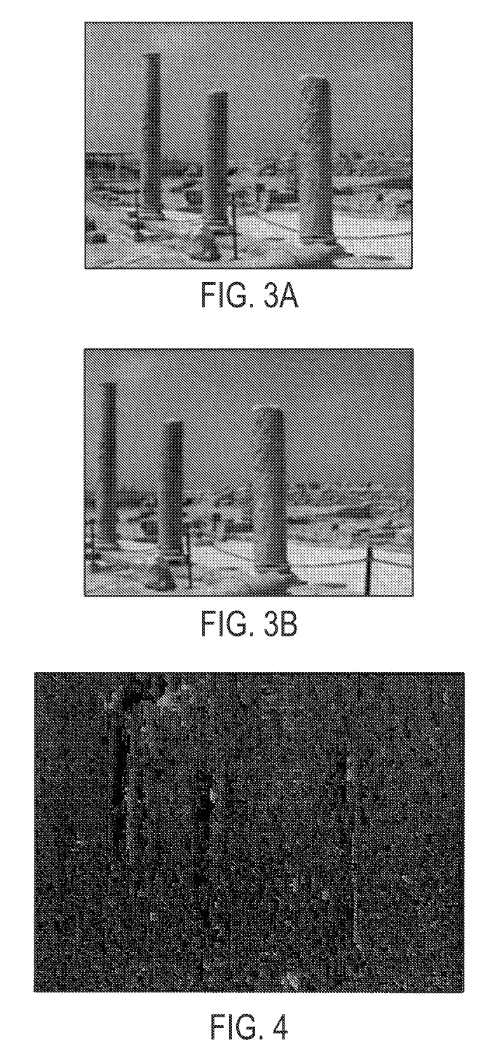

FIGS. 3A and 3B show two adjacent video frames;

FIG. 4 shows a displacement map derived from frames shown in FIGS. 3A and 3B,

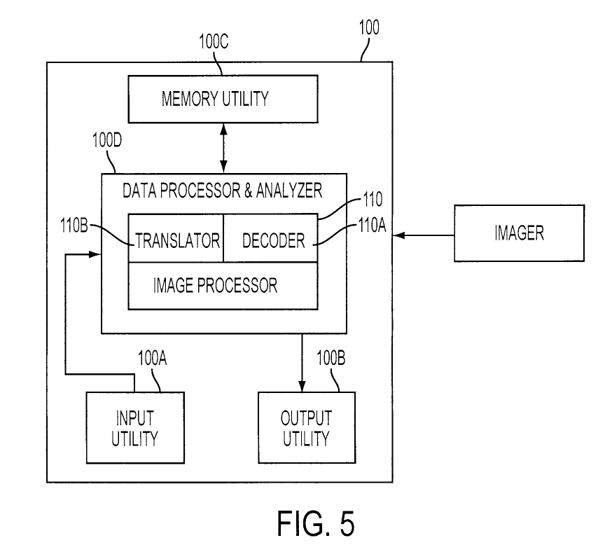

FIG. 5 is an example of a system structured to perform the method of the invention exemplified in FIG. 2, i.e. structured for creating (synthesizing) a 3D image (an anaglyph) out of a 2D image and horizontal and vertical displacement maps.

Referring to FIG. 1, there is illustrated a basic step of the block-matching algorithm (BMA) that is used in Motion Estimation CODECs (e.g. in MPEG-4). A current frame is split (e.g by a grid) into macroblocks, for which motion estimation is done. In the illustration a MacroBlock MB is being processed. The motion estimation is based on a search scheme which tries to find “the best matching position” for the 16×16 macroblock MB in a reference (typically previous) frame. The “best matching position” is searched within a predetermined or adaptive search range in the reference frame. Macroblock MB is thus matched with the same or another (but generally similar) 16×16 block. A matching position, relative to the original position, is referred to as a motion vector MV, which is transmitted in the bit stream to the video decoder. The BMA is the most popular algorithm for motion estimation in standardized video compression schemes.

Referring again to FIG. 1, Iₖ(x,y) is defined as a pixel intensity (luminance or Y component) at location (x,y) in the k-th frame (k-th Video Object Plane (VOP), in MPEG-4 parlance, or current frame), and Iₖ₋₁(x,y) is a pixel intensity at location (x, y) at the (k−1)-th frame (reference frame). For BMA motion estimation Iₖ₋₁(x, y), represents usually a pixel located in the search area (range) of pixel size R²=Rₓ×R_{y}. The reference frame may be not the previous frame, although usually it is. The maximum motion vector displacement is defined by the range and here it is [−p, p−1]. The block is typically square of a size N²=N×N pixels, where N=16 is usually used for generic motion estimation and N=8 and/or 4 is used for the advanced prediction (if the respective mode is used). Besides determining motion vector MV in integer pixels, the BMA determines also vector MV in fraction pixels such as half-pixel and/or quarter-pixel (or, in other words, the BMA determines also fraction MV positions).

In each individual search position of a search scheme, a candidate displacement vector CMV=(Δx, Δy) having horizontal and vertical components is attempted. The “best matching position” is then found by selection from the candidate positions using an error measure criterion.

As it is typical in practice, the sum of absolute differences (SAD) used as the error measure for video coding schemes can be used as in a criterion in the technique of the inventors. For all pixels within the block in the current frame, their luminance values are subtracted from the corresponding pixels values from the candidate block in the reference (e.g. previous) frame and the absolute values of these differences are determined. Then all the results are summarized. When the minimum of the sum is reached, the motion vector MV for this MacroBlock is declared to be found.

Reference is now made to FIG. 2, exemplifying a flowchart for creating (in other terms, synthesizing or decoding) a 3D image from a single 2D image and two “directional” displacement maps.

These source data could be produced as discussed above: a motion estimation algorithm located the blocks of the image and determined their movement when it compressed a 2D video sequence to which the image belonged. And values of the determined motion vectors for the X- and Y-axes yielded two displacement maps—a horizontal displacement map and a vertical displacement map. (The maps could be determined with sub-pixel accuracy: in particular, MPEG-4 supports Sub MacroBlocks down to 4×4 pixels; and it is used to encode a 2D video sequence with global movement, the motion can be estimated between 4×4 pixel Sub MacroBlocks of two sequential frames with a ¼ pixel accuracy).

So, in the decoder side, the 2D frame and the displacement maps are used for producing a stereoscopic 3D image. The source 2D frame may be compressed (i.e. intraframe coded) or not compressed; if it is compressed it can be decompressed.

As shown in the illustration, the 2D image is decoded from the video bitstream. The displacement map is translated into depth maps, Depth map X and Depth map Y. For simple translational motion, displacement is homomorphic to depth. For more complex motion, different approaches can be used.

In particular, one method to translate horizontal and vertical displacement is to calculate the amplitude of both motion types:

D=\sqrt{MVₓ²+MV_{y}²} (1)

where D is the computed depth per pixel, MVₓ and MV_{y} are motion vectors for the X and Y directions, respectively. The motivation for this transformation is that closer moving objects would have larger displacement. The map may be linearly or non linearly scaled.

Then, the Red component of the 2D image is expanded (using interpolation) 4 times for the X-axis (the reason for four times interpolation is that in this example motion vectors values have ¼ pixels accuracy). Once the image is expanded it is resampled according to the depth map

I(x,y)=Iₑ(x+D,y) (2)

where I(x,y) is the new artificial image, Iₑ is the interpolated image and D is the depth map value.

A new video 3D video frame is then created. It can be, for instance, an anaglyph formed by using the Green and the Blue components from the original 2D decoded image and a Red component from the new artificial image. Any other visualization method can be used as well.

The motion estimation in this method is performed using Sub MacroBlocks of 4×4 pixels. Therefore, when creating the depth map, interpolation of the motion vectors to all 16 pixels in the sub MacroBlock is used. In one simple realization, first order nearest (bilinear) interpolation is used. It is also possible to use higher order interpolation schemes, however it should be understood interpolation does not “add” information or increase informational resolution.

Examples of adjacent video frames and the resulting disparity map are shown in FIGS. 3A-3B and FIG. 4, respectively: FIGS. 3A and 3B show two sequential frames of a video and FIGS. 4 show a depth displacement map calculated from the motion along both the X-axis and Y-axis. Three vertical traces are visible in FIG. 4; these traces correspond to the three columns in FIGS. 3A and 3B.

The modified MPEG 4 encoder depicted above has the following outputs:

1. Standard H.264/ACV “most efficient” bit stream;

2. Horizontal displacement-map;

3. Vertical displacement-map; and

4. Skip MacroBlocks map.

For those embodiments of the decoder which would use translation (1) and Sub MarcoBlocks all four encoder's outputs would be useful.

Decoder may use also other data or parameters. In particular, two other parameters may be used to control the dynamic range of depth map values. While the encoder solves a problem of 2D compression, it produces the depth maps (disparity maps) according to the real values of the motion vectors. The decoder, however, according to the inventors' technique, can be aimed at a problem of 3D visualization rather than 2D decompression (it can be aimed at both).The decoder therefore may be provided with an ability to perform some manipulations in order to reduce artifacts and ghosting phenomena. In a simple implementation, an exemplary value a of the depth map, normalized to its maximal value, may be multiplied by a gain (A) and raised to the power of P constituting the P-th law transformation as follows:

D̅M̅=A·a^{P} (3)

The modified depth map is translated into a horizontal parallax map which is then used for synthesis of artificial stereo pairs. Once the artificial stereo pair is synthesized, it can be displayed on any standard projection device.

Another measure to reduce ghosting artifacts is smoothing by applying low pass filtering to the red channel. This results in images that are easier to fuse in 3D and contain less visual artifacts in 2D.

Thus, the inventors' technique provides a method for generating depth maps from a sequence of continuous scene 2D video frames by extracting the motion vectors from compressed video and synthesizing 3D images with reduced artifacts. This entire process has been implemented in real-time on a standard computer without any hardware acceleration.

FIG. 5 shows, by way of a block diagram, an image processing system 100 capable of carrying out some of the methods of the present invention. A specific system capable of carrying out a particular method of the present invention also can be built. System 100 is a computer system, including inter alia data input and output utilities 100A and 100B, a memory utility 100C, and a data processing and analyzing utility 100D. The latter includes inter alia an image processor utility 110 (i.e. API) configured and operable according to the invention to carry out a method of the present invention.

More specifically, considering the method generally similar to that exemplified in FIG. 2, image processor utility 110 is configured to receive image data (video bit stream), e.g. directly from an imager connectable to system 100 via wires or wireless signal transmission, or from memory utility 100C where such image data have been previously stored. Image processor utility 110 includes a decoder 110A adapted to process the video bitstream to decode a 2D image data, and a translator utility 110B adapted to receive motion data (e.g. from a motion sensor) and translate the displacement map into depth maps along the X- and Y-axes.

For simple translational motion, displacement is homomorphic to depth. For more complex motion, different approaches can be used. One method to translate horizontal and vertical displacement is to calculate the amplitude of both motion types according to equation (1) above. The motivation for this transformation is that closer moving objects have larger displacement. Then, as indicated above, the Red component of the 2D image is expanded (using interpolation) four times for the X-axis, and resampled according to the depth map (equation (2) above). A new video 3D video frame is then created. The motion estimation is performed using MacroBlocks of pixels (e.g. 4×4 pixels in the block).

Those skilled in the art will readily appreciate that various modifications and changes can be applied to the embodiments of the invention as hereinbefore described without departing from its scope defined in and by the appended claims.

1. A memory storage device readable by machine, the device tangibly embodying a sequence of depth maps associated with a continuous scene sequence of digital 2D images of a predetermined resolution, said sequence of depth maps including at least one restricted redundancy depth map of a resolution lower than the predetermined resolution of the 2D images.

2. The memory storage device of claim 1, wherein said sequence of depth maps is stored in a single data structure.

3. A kit comprising the memory storage device of claim 1 and a second memory storage device readable by machine, the second device tangibly embodying said continuous scene sequence of 2D images.

4. The memory storage device of claim 1, tangibly embodying said continuous scene sequence of 2D images.

5. The memory storage device of claim 4, wherein the continuous scene sequence of 2D images is stored in a single data structure.

6. The memory storage device of claim 5, wherein said single data structure is an MPEG-based file.

7. The memory storage device of claim 5 wherein the data structure comprising said sequence of digital 2D images comprises the respective sequence of depth maps.

8. The memory storage device of claim 3, wherein said sequence of digital 2D images is coded by Block Matching Algorithm.

9. The memory storage device of claim 4, wherein said sequence of digital 2D images is coded by Block Matching Algorithm.

10. The memory storage device of claim 1, wherein in at least one direction said restricted redundancy depth map is of a resolution at least 4 times lower than the predetermined resolution of digital 2D image associated with the depth map, the restricted redundancy depth map being thereby a low resolution depth map.

11. The memory storage device of claim 10 wherein the low resolution is at least 8 times lower than the predetermined resolution of digital 2D image associated with the depth map.

12. The memory storage device of claim 11 wherein the low resolution is at least 10 times lower than the predetermined resolution of digital 2D image associated with the depth map.

13. The memory storage device of claim 12 wherein the low resolution is at least 16 times lower than the predetermined resolution of digital 2D image associated with the depth map.

14. The memory storage device of claim 1 wherein in at least one direction said restricted redundancy depth map is of a resolution at least 3 times and at most 8 times lower than the predetermined resolution of digital 2D image associated with the depth map.

15. The memory storage device of claim 11 wherein the low resolution is at most 7 times lower than the predetermined resolution of digital 2D image associated with the depth map.

16. The memory storage device of claim 1 wherein in each of two crossed directions said restricted redundancy depth map is of resolution at least 4 times lower than the predetermined resolution of digital 2D image associated with the depth map.

17. A method of use of the memory storage device of claim 1, the method comprising initiating machine reading of said sequence of depth maps accommodated in the memory storage device and sending at least a portion of the read data to a network, the method thereby allowing a user of the memory storage device to distribute stereoscopic video-related data through the network.

18. The method of claim 17, comprising receiving said portion of the read data through the network, said receiving being performed at a terminal of a remotely located user, the method thereby enabling the remotely located user to access the stereoscopic video-related data through the network.

19. The method of claim 18, wherein said initiating comprises forming a network-passable initiating message and sending this message to the machine through said network, said forming and sending being performed at the terminal of the remotely located user.

20. A method of use of the memory storage device of claim 1, the method comprising administering a machine capable of reading the memory storage device to respond to a predetermined initiating signal to be received by the machine from a network, the response comprising reading the sequence of depth maps stored in the memory storage device and sending at least a portion of the read data to the network, the method thereby enabling a machine administrator to use the memory storage device as a stereoscopic video-related distributing terminal.

21. A method of use of the memory storage device of claim 1, the method comprising reading by a machine the sequence of depth maps stored in the memory storage device and generating by said machine a sequence of stereoscopic images using the read data and the associated sequence of 2D images, the generated sequence thereby including at least one restricted redundancy stereoscopically perceptible image.

22. The method of claim 21 wherein said generating the sequence of stereoscopic images comprises adapting this sequence for stereopsis.

23. The method of claim 22 wherein said generating the sequence of stereoscopic images comprises forming a sequence of anaglyphs.

24. The method of claim 21 wherein said generating the sequence of stereoscopic images comprises forming this sequence on a stereoscopic display.

25. The method of claim 23 wherein the forming of at least one of the anaglyphs comprises the following:
producing a green-blue component of anaglyph from a green and a blue component of a digital 2D image of the sequence of digital 2D images,
producing a red component of anaglyph I_{anaglyph} (x,y) from a red component, I_{red} (x,y), of the digital 2D image and the depth map, D (x,y), associated with the 2D image, x and y being two axes of the 2D image, said producing comprising:
producing a stretched red component I_{stretched} (x,y) by stretching the red component I_{red} (x,y) of the digital 2D image, the stretched red component I_{stretched} (x,y) thereby having more pixels along the axis x than the red component I_{red} (x,y),
resampling the stretched red component I_{stretched} (x,y) by assigning to a pixel (x,y) of the anaglyph red component an intensity of red color I_{anaglyph} (x,y)=I_{stretched} (x+D,y).

26. The method of claim 25 wherein said stretching the red component I_{red} (x,y) of the digital 2D image comprises interpolating values of the stretched red component, I_{stretched} (x,y), that is being produced.

27. A method for use in machine conversion of 2D video to 3D video, the method comprising generating a sequence of stereoscopic images by processing a continuous scene sequence of digital 2D images and a sequence of depth maps associated with said continuous scene sequence of digital 2D images, wherein said sequence of depth maps includes at least one restricted redundancy depth map being of a resolution lower than the 2D image, the generated sequence of the stereoscopic images thereby including at least one restricted redundancy stereoscopically perceptible image.

28. The method of claim 27, wherein the continuous scene sequence of digital 2D images is coded by a block matching algorithm.

29. The method of claim 28, wherein said processing comprises forming a sequence of anaglyphs from said continuous scene sequence of digital 2D images and said sequence of depth maps associated with said continuous scene sequence of digital 2D images.

30. The method of claim 29 wherein at least one of the anaglyphs to be included into said sequence of anaglyphs is formed by carrying out the following:
producing a green-blue component of the anaglyph from a green and a blue component of a digital 2D image of said sequence of digital 2D images,
producing a red component of the anaglyph I_{anaglyph} (x,y) from a red component, I_{red} (x,y), of the digital 2D image and the depth map, D(x,y), associated with the 2D image, x and y being two arbitrary axes of the 2D image, said producing comprising:
producing a stretched red component I_{stretched} (x,y) by stretching the red component I_{red}(x,y) of the digital 2D image, the stretched red component I_{stretched} (x,y) thereby having more pixels along the axis x than the red component I_{red} (x,y),
resampling the stretched red component I_{stretched} (x,y) by assigning to a pixel (x,y) an intensity of red color I_{anaglyph} (x,y)=I_{stretched} (x+D,y).

31. The method of claim 30 wherein said stretching the red component I_{red} (x,y) of the digital 2D image comprises interpolating values of the stretched red component I_{stretched} (x,y) being produced.

32. A program storage device readable by machine, tangibly embodying a program of instructions executable by the machine to perform method steps of claim 27.

33. A computer program product comprising a computer useable medium having computer readable program code embodied therein, the computer program product comprising computer readable program code for causing the computer to perform the method of claim 27.

34. A computer system comprising a computer and the computer program product of claim 33.

35. The method of claim 27, wherein the restricted redundancy depth map associated with the digital 2D image of the continuous scene sequence of 2D images is of a resolution which is at least 4 times lower than the resolution of the 2D image associated with said restricted redundancy depth map.

36. A method of use of a 2D video coded by a Block Matching Algorithm, the method comprising accessing by a machine a continuous scene sequence of digital 2D images coded in the 2D video, accessing by said machine multipixel image portions motion data, associated with said continuous scene sequence of digital 2D images and coded in the 2D video, and generating by said machine a sequence of restricted redundancy stereoscopically perceptible images by processing the accessed sequence and motion data, the method thereby enabling t use of machine for conversion of 2D video to 3D video.

37. The method of claim 36, wherein said generating comprises calculating by said machine a sequence of restricted redundancy depth maps by using the accessed multipixel image portions motion data.

38. The method of claim 37, wherein said calculating the sequence of restricted redundancy depth map comprises assigning a depth D (x,y) to pixels of a multipixel image portion of a digital 2D image of the sequence of digital 2D images, the value being homomorphic to MVₓ and MV_{y} being two motion vectors, coded in the 2D video, of said multipixel image portion.

39. The method of claim 37, wherein said calculating the sequence of restricted redundancy depth map comprises assigning a depth D (x,y) a value of about \sqrt{MVₓ²+MV_{y}²} to pixels of a multipixel image portion of a digital 2D image of the sequence of digital 2D images, MVₓ and MV_{y} being two motion vectors, coded in the 2D video, of said multipixel image portion.

40. The method of claim 39 wherein said value is truncated or rounded to a pixel.

41. A program storage device readable by machine, tangibly embodying a program of instructions executable by the machine to perform method steps, the method comprising the method of claim 37.

42. A computer program product comprising a computer useable medium having computer readable program code embodied therein, the computer program product comprising computer readable program code for causing the computer to perform the method of claim 37.

43. A computer system comprising a computer and the computer program product of claim 42 associated with said computer.

44. The method of claim 36, wherein said multipixel image portions are of a size being at least 4 pixels in an at least one direction.

45. A method, for use in 3D video compression, the method comprising accessing a continuous scene sequence of stereoscopic images, obtaining, using the accessed sequence, a sequence of digital 2D images, calculating a sequence of restricted redundancy depth maps being associated with said sequence of digital 2D images, the restricted redundancy depth maps being of resolution larger than the 3 pixels of the digital 2D images, including the calculated sequence of restricted redundancy depth maps in a data structure being tangibly embodied in a memory storage device readable by machine, the resulting data structure thereby accommodating stereoscopic video-related data.

46. The method of claim 45, comprising including the obtained sequence of digital 2D images in a data structure being tangibly embodied in a memory storage device readable by machine.

47. The method of claim 46, wherein the data structure including the obtained sequence of digital 2D images and the data structure including the calculated sequence of the restricted redundancy depth maps are being embodied by the same memory storage device readable by machine.

48. The method of claim 47, wherein the obtained sequence of digital 2D images and the calculated sequence of the restricted redundancy depth maps are included in the same data structure.

49. The method of claim 45 wherein said obtained sequence of digital 2D images is coded by a Block Matching Algorithm.

50. A program storage device readable by machine, tangibly embodying a program of instructions executable by the machine to perform the method of claim 45.

51. A computer program product comprising a computer useable medium having computer readable program code embodied therein, the computer program product comprising computer readable program code for causing the computer to perform the method of claim 45.

52. A computer system comprising a computer and the computer program product of claim 51 associated with said computer.

53. The method of claims 45, wherein the sequence of the restricted redundancy depth maps contains a restricted redundancy depth map of a resolution at least 4 times lower than the resolution of the 2D image associated with said restricted redundancy depth map.

54. A memory storage device readable by machine, the device tangibly embodying a continuous scene sequence of 2D images of a predetermined resolution and a sequence of depth maps associated with said sequence of digital 2D images, the sequence of depth maps comprising at least one restricted redundancy depth map of a resolution lower than the predetermined resolution of the 2D images, the sequence of digital 2D images being coded by a Block Matching Algorithm, said restricted redundancy depth map being in at least one direction of a resolution at least 4 times lower than the predetermined resolution of digital 2D image associated with the depth map.

55. The memory storage device of claim 1, wherein said restricted redundancy depth map comprises interpolated values within its blocks.
